(19) United States
(12) Patent Application Publication
(10) Pub. No.: US 2026/0023260 A1
(43) Pub. Date: Jan. 22, 2026

(54) IMAGE DISPLAY DEVICE

(71) Applicant: YAZAKI CORPORATION, Tokyo (JP)

(72) Inventor: Nobuyuki Takahashi, Susono-shi (JP)

(21) Appl. No.: 19/263,512

(22) Filed: Jul. 9, 2025

(30) Foreign Application Priority Data
Jul. 17, 2024 (JP) 2024-113751

(51) Int. Cl. G02B 27/01

(52) U.S. Cl. CPC G02B 27/0101; G02B 27/0149; G02B 2027/0118

(57) ABSTRACT

An image display device includes a display unit that emits display light; and an optical unit that reflects the display light and projects the display light to a display member. The display unit includes a metal circuit board on which a plurality of light-emitting elements is mounted, a display that receives light emitted from the light-emitting element and emits the display light, and a control unit that controls light emission luminance of the light-emitting elements. The light-emitting elements are arrayed on the metal circuit board, and the control unit is capable of individually adjusting the light emission luminance of the light-emitting elements for each row of the array.

### CROSS-REFERENCE TO RELATED APPLICATION(S)

The present application claims priority to and incorporates by reference the entire contents of Japanese Patent Application No. 2024-113751 filed in Japan on Jul. 17, 2024.

### BACKGROUND OF THE INVENTION

### 1. Field of the Invention

The present invention relates to an image display device.

### 2. Description of the Related Art

In the related art, as an image display device, for example, as disclosed in JP 2011-165 624 A, an image display device including a display (display), a plurality of light sources illuminating the display, and a circuit board on which a plurality of light sources is mounted is known. In this image display device, the plurality of light sources are arrayed in intersecting directions of the surface of the circuit board to form a backlight, and light is given to a display such as a liquid crystal to generate display light.

The above-described image display device disclosed in JP 2011-165 624 A has room for improvement in that unevenness in display luminance easily occurs. For example, even when the same current is applied to the plurality of light sources to operate, the luminance may become non-uniform in a display range of the display, and the luminance may become higher toward the central portion.

### SUMMARY OF THE INVENTION

Accordingly, an object of the present invention is to provide an image display device capable of curbing display luminance unevenness.

In order to achieve the above mentioned object, an image display device according to one aspect of the present invention includes a display unit configured to emit display light; and an optical unit configured to reflect the display light and project the display light to a display member, wherein the display unit includes a circuit board on which a plurality of light-emitting elements is mounted, a display that receives light emitted from the light-emitting element and emits the display light, and a control unit that controls light emission luminance of the light-emitting element, the light-emitting elements are arrayed on the circuit board, and the control unit is capable of individually adjusting the light emission luminance of the light-emitting element for each row of the array.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic configuration of an image display device according to an embodiment;

FIG. 2 is a perspective view illustrating a display unit of the image display device according to the embodiment;

FIG. 3 is an exploded perspective view illustrating the display unit of the image display device according to the embodiment;

FIG. 4 is a perspective view illustrating an overview of a metal circuit board of the image display device according to the embodiment;

FIG. 5 is a diagram illustrating disposition of light-emitting elements of the image display device according to the embodiment;

FIG. 6 is a diagram illustrating a current value of a light-emitting element of the image display device according to the embodiment;

FIG. 7 is a diagram illustrating display luminance of a display of the image display device according to the embodiment;

FIG. 8 is a diagram illustrating a display state of the display of the image display device according to the embodiment;

FIG. 9 is a diagram illustrating a current value of a light-emitting element in an image display device according to a comparative example;

FIG. 10 is a diagram of display luminance of a display in an image display device according to the comparative example;

FIG. 11 is a diagram illustrating a display state of the display in the image display device according to the comparative example;

FIG. 12 is a diagram illustrating a current value of the light-emitting element in the image display device according to the comparative example;

FIG. 13 is a diagram illustrating display luminance of the display in the image display device according to the comparative example; and

FIG. 14 is a diagram illustrating a display state of a display in an image display device according to the comparative example.

### DETAILED DESCRIPTION OF THE PREFERRED EMBODIMENTS

Hereinafter, an embodiment according to the present invention will be described in detail with reference to the drawings. The present invention is not limited by the embodiment. Constituents in the following embodiments include those that can be easily replaced by those skilled in the art or those that are substantially the same.

### Embodiment

The embodiment relates to an image display device. In the following description, of first, second, and third directions intersecting each other, the first direction is referred to as a “front-rear direction X”, the second direction is referred to as a “vehicle width direction Y”, and the third direction is referred to as a “height direction Z”. Here, the front-rear direction X, the vehicle width direction Y, and the height direction Z are orthogonal to each other. The front-rear direction X corresponds to the front-rear direction of a vehicle on which the image display device is mounted. The vehicle width direction Y corresponds to the vehicle width direction of the vehicle on which the image display device is mounted. The vehicle width direction Y and the height direction Z correspond to intersecting directions intersecting the front-rear direction X. Each direction used in the following description represents a direction in a state where each unit is mounted on a vehicle unless otherwise specified. The term “orthogonal” as used herein includes substantially orthogonal.

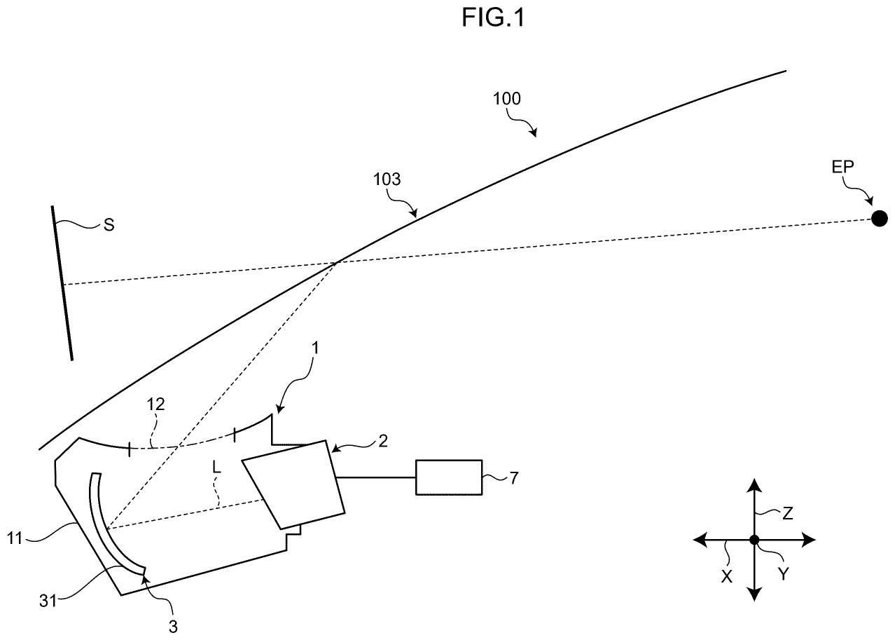

As illustrated in FIG. 1, an image display device 1 is a device that is installed in a vehicle 100 and displays an image. For example, the image display device 1 is a head-up display device that projects display light L to a display member 103 of the vehicle 100 to display a virtual image S. In the vehicle 100, the image display device 1 projects the display light L to the display member 103 and causes a driver of the vehicle 100 to recognize the virtual image S in front of an eye point EP. The display member 103 is, for example, a windshield. The image display device 1 is disposed below the display member 103 and is installed, for example, inside an instrument panel provided on a dashboard. The eye point EP is assumed in advance as a viewpoint position of the driver.

The image display device 1 includes a display unit 2, an optical unit 3, and a control unit 7. The display unit 2 and the optical unit 3 are housed or installed in a housing 11, and emit the display light L from an opening 12 to the display member 103. The control unit 7 is installed outside of the housing 11, for example, and is electrically connected to the display unit 2.

The optical unit 3 is an optical system unit that reflects the display light L and guides the display light L toward the display member 103, and is configured by, for example, a mirror 31. The mirror 31 reflects the display light L emitted from the display unit 2 and projects the display light L to the display member 103 through the opening 12. The mirror 31 has, for example, a concave reflection surface and can enlarge an image. The shape of the reflection surface is, for example, a free-form surface, and can be a shape capable of correcting image distortion and aberration. Although FIG. 1 illustrates a case where the optical unit 3 is configured by one mirror 31, the optical unit 3 may be configured by a plurality of mirrors and reflect the display light L a plurality of times.

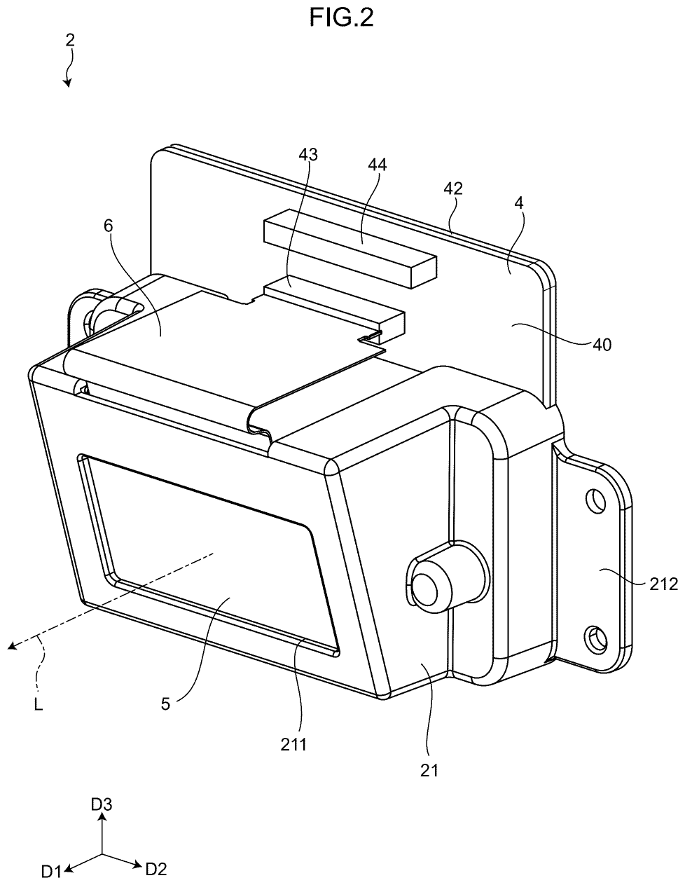

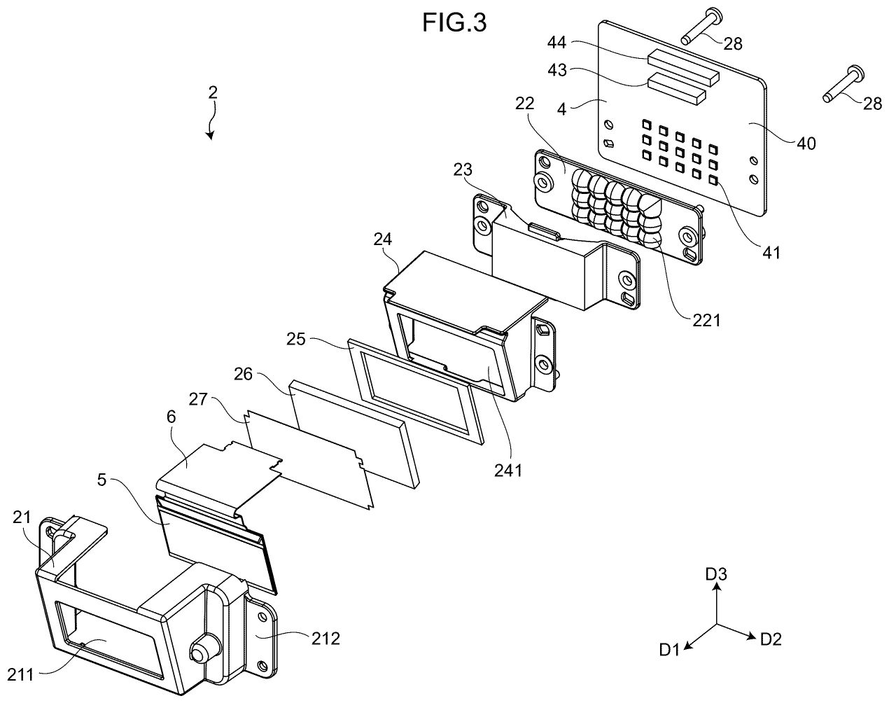

As illustrated in FIGS. 2 and 3, the display unit 2 is a unit that generates and outputs the display light L, and includes a metal circuit board 4, a display 5, and a wiring member 6. For example, the display unit 2 is configured by attaching a cover 21 to the metal circuit board 4 and is configured by sequentially disposing a condenser lens 22, a light distribution lens 23, a case 24, a frame member 25, a sheet material 26, a sheet material 27, and the display 5 between the metal circuit board 4 and the cover 21. In the drawing, a depth direction of the display unit 2 is referred to as a “unit front-rear direction D1”, a width direction is referred to as a “unit width direction D2”, and a height direction is referred to as a “unit height direction D3”. The unit front-rear direction D1, the unit width direction D2, and the unit height direction D3 are orthogonal to each other. The unit front-rear direction D1 is typically a direction oriented along an emission direction of the display light L or a direction oriented along the thickness direction of the metal circuit board 4, and is a direction diagonally intersecting the front-rear direction X illustrated in FIG. 1 in an installation state on the vehicle 100. The unit width direction D2 is typically a direction oriented along the vehicle width direction Y illustrated in FIG. 1.

The metal circuit board 4 is a circuit board on which alight-emitting element 41 is mounted, and is a component included in a backlight. For example, the metal circuit board 4 has a plate-shaped metal member 42, and the light-emitting element 41 is mounted on the metal member 42 via an insulating layer. The metal member 42 is provided to be stacked in the thickness direction of the metal circuit board 4 and is formed to have the same size as a main surface 40 of the metal circuit board 4. The same size here includes substantially the same size. As the metal member 42, for example, a plate material containing aluminum as a main component is used. An aluminum plate material, an aluminum alloy plate material, or the like corresponds to the plate material containing aluminum as a main component. In the image display device 1 according to the embodiment, by using the metal circuit board 4 as the circuit board on which the light-emitting element 41 is mounted, it is possible to prevent heat generated by the light-emitting element 41 from being diffused through the metal member 42, and curb a high temperature state of the light-emitting element 41. In the image display device 1 according to the embodiment, since heat dissipation can be enhanced by the metal circuit board 4, which can omit installation of heat dissipation fins and the like and miniaturize the device.

The main surface 40 of the metal circuit board 4 is a surface of the plate-shaped metal circuit board 4 and is a surface formed in a direction intersecting the thickness direction. The thickness direction is a direction oriented along the unit front-rear direction D1. The light-emitting elements 41 are light sources that emit light to serve as a backlight, and a plurality of the light-emitting elements are arrayed and provided on the main surface 40 of the metal circuit board 4. As the light-emitting element 41, for example, a light emitting diode (LED) is used. The light-emitting element 41 is surface-mounted using, for example, a chip component. The light-emitting element 41 may be a component that has a lead wire and is inserted and mounted or may be a light emitting component other than the LED.

The cover 21 is a box-shaped component of which a surface facing the metal circuit board 4 is opened and, for example, is attached to the main surface 40 of the metal circuit board 4 and fixed with a screw 28. An emission window 211 is formed in the cover 21 so that the display light L can be emitted. The cover 21 has flange portions 212 formed at both ends in the unit width direction D2 and can be fixed to the housing 11, a member attached to the housing 11, or the like.

The condenser lens 22 is a lens that condenses light emitted from the light-emitting element 41 and is formed by a light-transmitting member. The condenser lens 22 includes a plurality of lens units 221 corresponding to the plurality of light-emitting elements 41, and condenses light emitted from each light-emitting element 41 by each lens unit 221. The lens unit 221 has a flat incidence surface and a protruding emission surface and is formed to face the light-emitting element 41. By providing the lens unit 221 for each of the plurality of light-emitting elements 41 in this manner, a light distribution angle or an irradiation angle of the light emitted from the light-emitting element 41 can be set small, and a distance between the condenser lens 22 and the light distribution lens 23 can be shortened. Therefore, in the image display device 1 according to the embodiment, the backlight unit including the light-emitting elements 41, the condenser lens 22, and the light distribution lens 23 can be made thin.

The light distribution lens 23 is a lens that adjusts a traveling direction of light emitted from the condenser lens 22 in a predetermined direction, and includes a light-transmitting member. The light distribution lens 23 is disposed to face the condenser lens 22.

The case 24 is provided to cover the condenser lens 22 and the light distribution lens 23 with the metal circuit board 4. For example, the case 24 is integrated with the metal circuit board 4, the condenser lens 22, the light distribution lens 23, and the cover 21 with screws 28. In other words, the screw 28 sequentially passes through the metal circuit board 4, the condenser lens 22, the light distribution lens 23, and the case 24 to be screwed into the cover 21. An opening 241 is formed in the case 24, and light emitted from the light distribution lens 23 can be guided in the unit front-rear direction D1.

The frame member 25, a sheet material 26, a sheet material 27, and the display 5 are provided between the case 24 and the cover 21. The sheet material 26 and the sheet material 27 are optical sheets. For example, diffusion sheets, condensing sheets, or the like are used.

The display 5 is a device disposed to face the light-emitting element 41, receives light emitted from the light-emitting element 41, and emits the display light L. For example, the display 5 emits the display light L by transmitting the optically processed light emitted from the light-emitting element 41. Specifically, a light transmissive TFT liquid crystal display (thin film transistor Liquid crystal display) is used as the display 5.

The wiring member 6 is connected to the display 5. The wiring member 6 is a wiring member for controlling the display 5, and electrically connects the display 5 to the metal circuit board 4. The wiring member 6 is configured by a planar circuit board. For example, a flexible printed circuit board is used. The wiring member 6 extends from a connection position with the display 5 to the outside of the cover 21 in the unit front-rear direction D1 and is connected to the metal circuit board 4. That is, the wiring member 6 is connected to a connector 43 mounted on the metal circuit board 4.

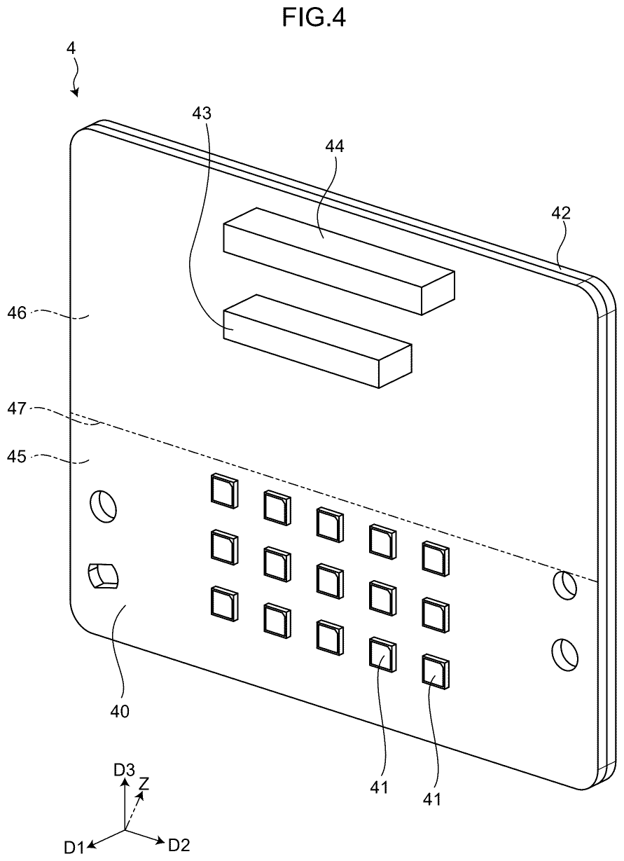

As illustrated in FIG. 4, the metal circuit board 4 is formed in a rectangular plate shape, and the light-emitting element 41 is mounted on the main surface 40. The plurality of light-emitting elements 41 are arrayed in two intersecting directions. For example, the plurality of the light-emitting elements 41 are arrayed in the unit width direction D2 and the unit height direction D3. Specifically, five light-emitting elements 41 are disposed in the unit width direction D2, three light-emitting elements 41 are disposed in the unit height direction D3, and a total of fifteen light-emitting elements 41 are disposed.

That is, as illustrated in FIG. 5, the light-emitting elements 41 are disposed in five rows including rows L11, L12, L13, L14, and L15 in the unit width direction D2, and are disposed in three rows including rows L21, L22, and L23 in the unit height direction D3. In the unit width direction D2, the rows L11 and L15 are end rows, the rows L12 and L14 are rows closer to the central portion than the end rows, and the row L13 is a row at the central portion. The rows L21 and L23 are end rows, and the row L22 is a row at the central portion. In the unit height direction D3, the rows L21 and L23 are end rows, and the row L22 is a row at the central portion. The number and array of the light-emitting elements 41 are not limited to those illustrated in FIG. 4.

The light-emitting elements 41 are provided so that the light emission luminance can be individually controlled. That is, the control unit 7 controls the light emission luminance by adjusting a current to be individually applied to the light-emitting element 41. For example, the control unit 7 can individually adjust the light emission luminance of the light-emitting element 41 for each row of the array. That is, the control unit 7 can adjust the light emission luminance of the light-emitting elements 41 for each row, and can set the light emission luminance of the light-emitting elements 41 in the same row to the same luminance. The light-emitting elements 41 in the same row may also be adjusted to different light emission luminance. The light-emitting elements 41 are connected to the control unit 7 via a light emission control connector 44. The light emission control connector 44 is mounted on the metal circuit board 4 and is connected to the light-emitting element 41 by a wiring member (not illustrated). In FIGS. 4 and 5, the connector 43 and the light emission control connector 44 are schematically illustrated.

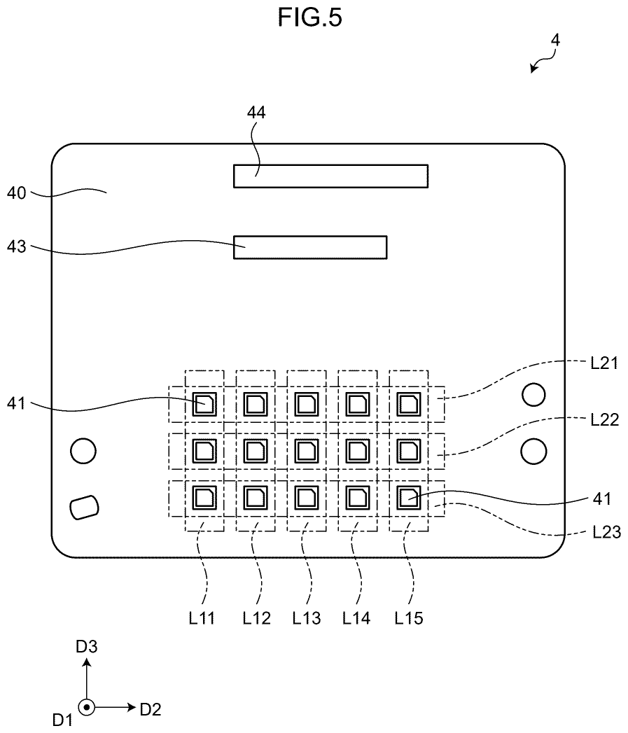

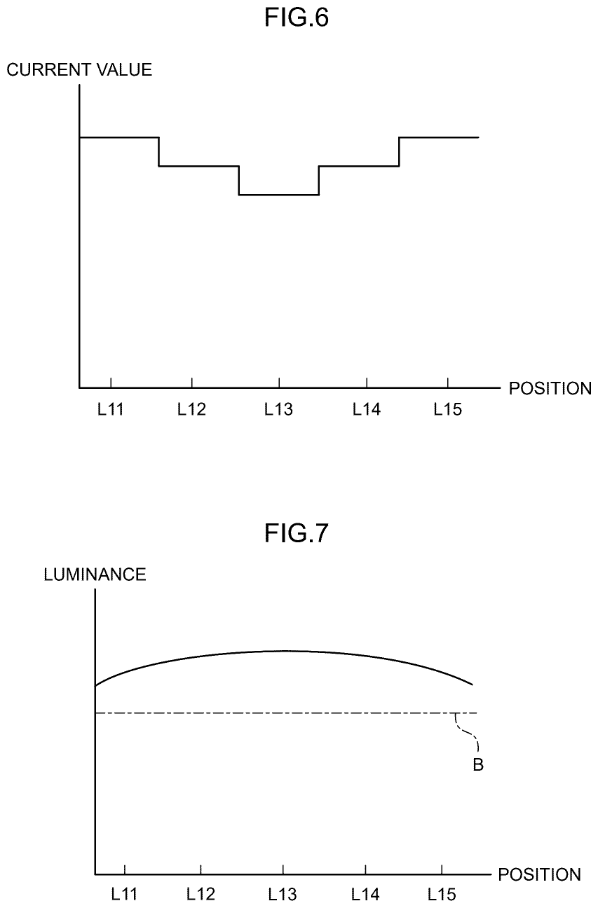

As illustrated in FIG. 6, the light emission luminance of the light-emitting element 41 is adjusted so that a current value to be applied decreases from the end portion to the central portion of the array. That is, the control unit 7 adjusts the light emission luminance by lowering the current value to be applied to the light-emitting element 41 from the end portion to the central portion of the array. Specifically, in the rows L11, L12, L13, L14, and L15 in the unit width direction D2, the current values applied to the light-emitting element 41 are lowered from the end portion to the central portion of the array, and thus the light emission luminance is adjusted. That is, in the light-emitting elements 41 in the row L12, a current value of the current applied from the light-emitting elements 41 in the row L11 is small. In the light-emitting elements 41 in the row L13, a current value of the current applied from the light-emitting elements 41 in the row L12 is small. In the light-emitting elements 41 in the row L14, a current value of the current applied from the light-emitting elements 41 in the row L15 is small. In the light-emitting element 41 in the row L13, a current value of the current applied from the light-emitting elements 41 in the row L12 is small.

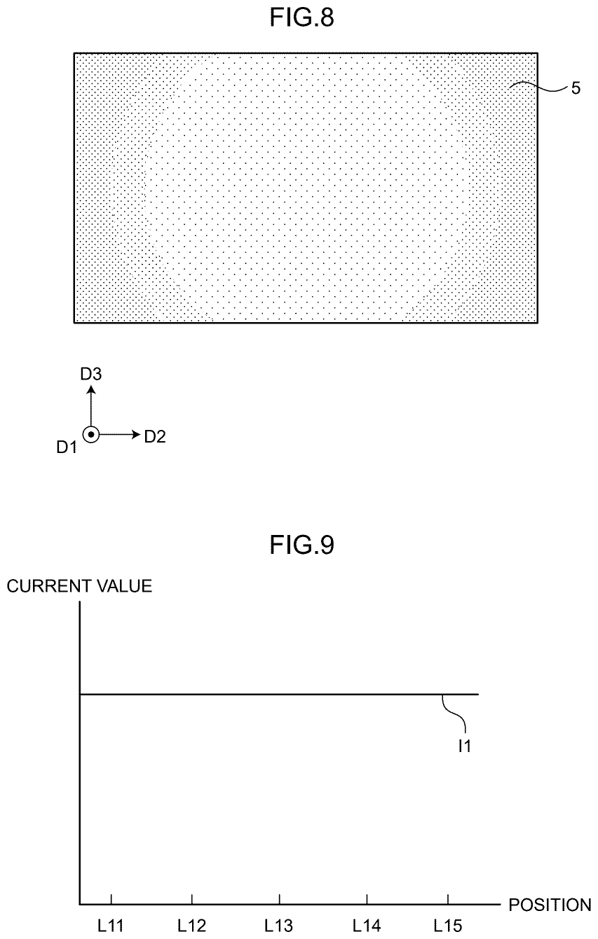

As illustrated in FIG. 7, display luminance of the display 5 is higher at the central portion corresponding to the row 13 of the light-emitting elements 41 and is lowered toward the end portion. Then, display luminance of the display 5 corresponding to the end portions of the rows L11 and L15 of the light-emitting elements 41 is higher than reference luminance B. Therefore, as illustrated in FIG. 8, display luminance at the central portion is high in a display range of the display 5, but the display luminance at the end portion is also luminance exceeding the reference luminance B, which curbs the luminance unevenness.

As illustrated in FIG. 4, the metal circuit board 4 has a disposition region 45 and a non-disposition region 46. The non-disposition region 46 is provided at a position higher than the disposition region 45 in the vertical direction in the metal circuit board 4. In FIG. 4, the vertical direction is a direction oriented along the height direction Z and is a direction inclined with respect to the unit height direction D3. The metal circuit board 4 is provided in a direction intersecting the horizontal direction. That is, the metal circuit board 4 is provided so that the normal direction of the main surface 40 intersects the vertical direction. The normal direction of the main surface 40 is the unit front-rear direction D1, and the vertical direction is the height direction Z. When the metal circuit board 4 is not disposed so that the normal direction of the main surface 40 is the vertical direction, the non-disposition region 46 can be provided at a position higher than the disposition region 45. That is, when the metal circuit board 4 is disposed so that the main surface 40 is orthogonal to the vertical direction, the non-disposition region 46 and the disposition region 45 are located at the same height in the vertical direction. However, when the metal circuit board 4 is disposed so that the main surface 40 is not orthogonal to the vertical direction, the non-disposition region 46 can be provided at a position higher than the disposition region 45.

The disposition region 45 is a region where the light-emitting element 41 is disposed on the main surface 40 of the metal circuit board 4. The non-disposition region 46 is a region other than the disposition region 45 on the main surface 40 of the metal circuit board 4. For example, the disposition region 45 is a region below an upper end position 47 of the light-emitting element 41 disposed at the uppermost portion with respect to the unit height direction D3 on the main surface 40 of the metal circuit board 4. The non-disposition region 46 is a region above the upper end position 47 on the main surface 40 of the metal circuit board 4. That is, in the metal circuit board 4, the light-emitting elements 41 are mounted while being biased to a lower position. For example, the non-disposition region 46 is set to be larger than the disposition region 45.

The connector 43 connected to the wiring member 6 is mounted on the metal circuit board 4 together with the light-emitting element 41. Since the connector 43 is not a component that generates heat, for example, it is also conceivable to mount the connector 43 on a circuit board that does not include the metal member 42. However, in the image display device 1 according to the embodiment, the metal circuit board 4 can be formed largely by mounting the connector 43 on the metal circuit board 4. The connector 43 is installed, for example, in the non-disposition region 46 of the metal circuit board 4.

The connector 43 is mounted on the metal circuit board 4 at a position higher than the light-emitting element 41 in the vertical direction. For example, the connector 43 is provided in the non-disposition region 46 of the metal circuit board 4 and is mounted at a position higher than the light-emitting element 41 provided in the disposition region 45. Therefore, heat H generated from the light-emitting element 41 efficiently moves toward the connector 43.

Next, an operation of the image display device 1 according to the embodiment will be described.

In FIG. 2, in the operation of the image display device 1, a control signal is first input to the display 5 through the wiring member 6, and the display 5 generates an image according to the control signal. In FIG. 3, the operation signal is input to the light-emitting element 41, and the light-emitting element 41 emits light. The light emitted from the light-emitting element 41 is optically processed by the condenser lens 22, the light distribution lens 23, the sheet material 26, and the sheet material 27, and is incident on the display 5.

At this time, as illustrated in FIG. 6, in the light-emitting elements 41, light emission adjustment is individually performed in each row of the array. For example, a current value of a current applied to the light-emitting elements 41 is lowered from the end portion to the central portion of the array. For example, a current value of a current passed through the light-emitting elements 41 in the rows L11 and L15 is lowered than a current value of a current passed through the light-emitting elements 41 in the rows L12 and L14, and a current value of a current passed through the light-emitting elements 41 in the row L13 is lowered than a current value of a current passed through the light-emitting elements 41 in the rows L12 and L14. Accordingly, light emission luminance of the light-emitting elements 41 in the row L13 in the central portion is lowered and, as illustrated in FIGS. 7 and 8, the light emission luminance in the central portion is prevented from becoming too high in the display range of the display 5, which can curb luminance unevenness.

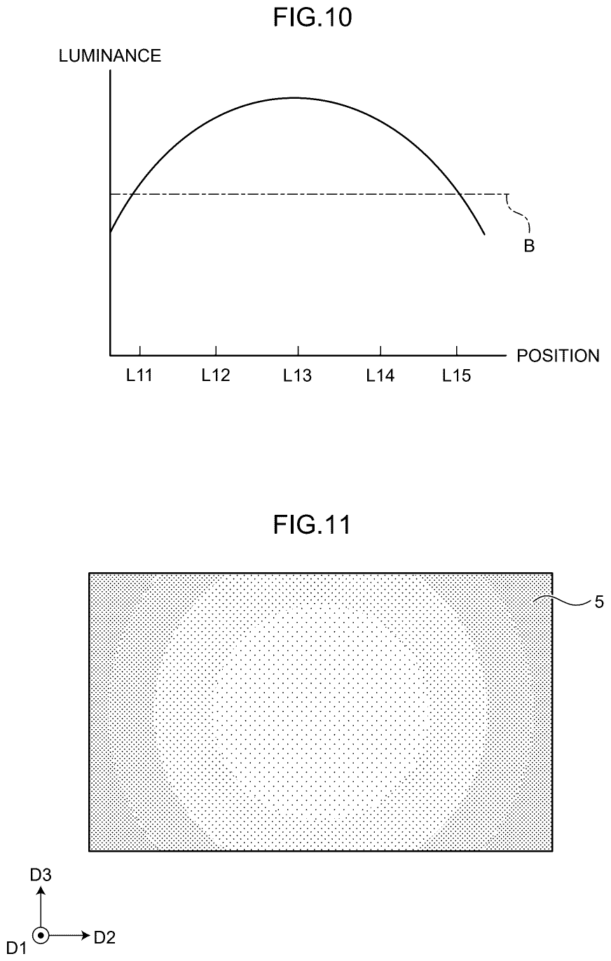

For example, as illustrated in FIG. 9, it is conceivable to apply a current having the same current value I1 to all the light-emitting elements 41. In this case, as illustrated in FIG. 10, the light emission luminance of the display 5 corresponding to the light-emitting elements 41 in the rows L11 and L15 at the end portion of the array is considerably lower than the light emission luminance of the display 5 corresponding to the light-emitting elements 41 in the row 13 at the central portion of the array. Therefore, the light emission luminance of the display 5 corresponding to the light-emitting elements 41 in the rows L11 and L15 at the end portion of the array may be lower than the reference luminance B. The reference luminance B is a preset luminance value and is a luminance value serving as an index of display luminance on the display 5. For example, the display 5 performs appropriate display when the display luminance is equal to or higher than the reference luminance B.

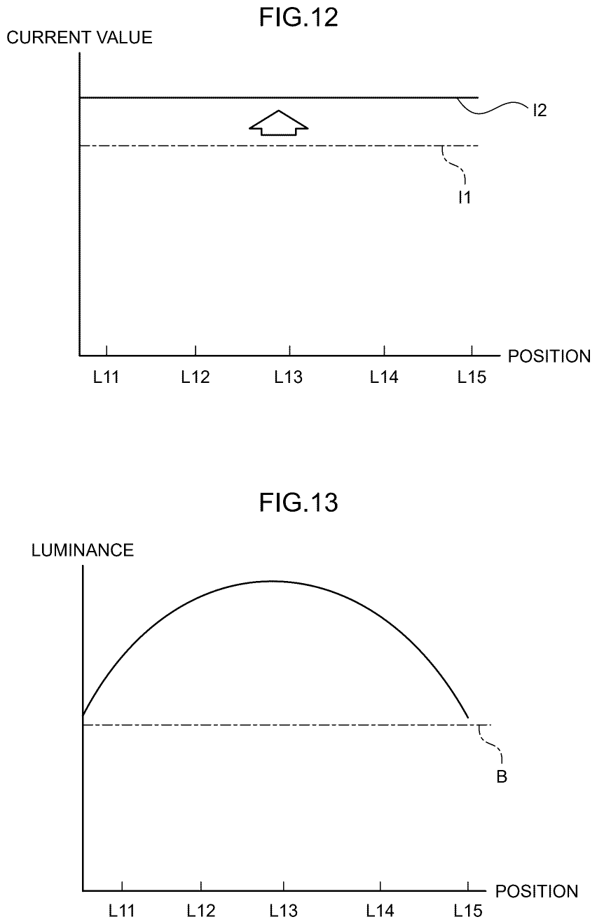

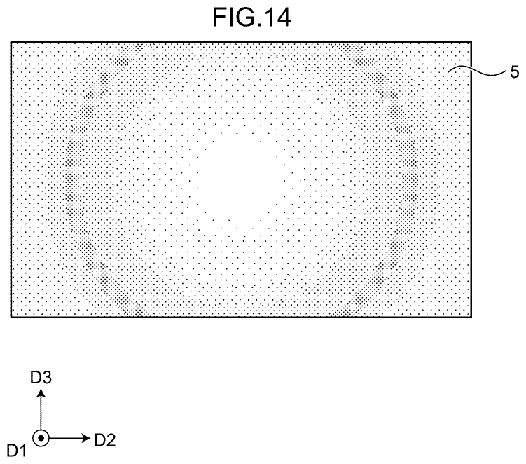

On the other hand, for example, as illustrated in FIG. 12, it is conceivable to increase the current value of the current passing through the light-emitting elements 41 from I1 to I2 so that the light emission luminance of the display 5 corresponding to the light-emitting elements 41 in the rows L11 and L15 at the end portion of the array exceeds the reference luminance B. In this case, however, as illustrated in FIGS. 13 and 14, the light emission luminance of the display 5 corresponding to the light-emitting elements 41 in the row 13 in the central portion of the array becomes high, and it is difficult to curb the luminance unevenness in the display range of the display 5. Heat generated from the light-emitting element 41 also increases, and there is concern of the light-emitting element 41 being in a high temperature state. Further, since a current supplied to the light-emitting element 41 increases, power consumption of the device increases.

Accordingly, in the image display device 1 according to the embodiment, the light emission of the light-emitting elements 41 can be adjusted individually in each row of the array, and the current value of the current applied to the light-emitting element 41 can be lowered from the end portion to the central portion of the array. Accordingly, the image display device 1 according to the embodiment can prevent the display luminance at the central portion from becoming too high in the display range of the display 5, which can curb the luminance unevenness. The image display device 1 according to the embodiment can prevent the heat generated from the light-emitting element 41 from increasing while curbing luminance unevenness of the display 5, and can prevent the light-emitting elements 41 from being in a high temperature state. Further, the image display device 1 according to the embodiment can curb an increase in power consumption.

Then, in FIG. 1, the display light L is output from the display 5. The display light L is reflected by the optical unit 3, is emitted from the opening 12, and is projected to the display member 103. The driver of the vehicle 100 can recognize the display light L projected to the display member 103 as the virtual image S.

As described above, the image display device 1 according to the embodiment includes the control unit 7 capable of individually adjusting the light emission luminance of the light-emitting elements 41 for each row of the array, which can curb the luminance unevenness in the display 5 while curbing the power consumption.

The image display device 1 according to the embodiment can prevent the display luminance of the display 5 from being excessively increased at the central portion by lowering the current value of the light-emitting elements 41 toward the central portion of the array, which can appropriately curb the luminance unevenness in the display 5.

Further, in the image display device 1 according to the embodiment, by using the metal circuit board 4 in which the plate-shaped metal members 42 are stacked as the circuit board, heat dissipation can be enhanced, which can omit installation of heat dissipation fins or the like and miniaturize the device.

Although the image display device according to the embodiment has been described, the image display device according to the present invention is not limited to the above-described embodiment, and various modifications can be made within the scope described in the claims. The image display device according to the embodiment may be configured by appropriately combining components of the embodiments and modifications described above.

For example, in the above-described embodiment, in the rows L11, L12, L13, L14, and L15 in the unit width direction D2, the current values to be applied to the light-emitting elements 41 are lowered from the end portion to the central portion of the array. In the rows L21, L22, and L23 in the unit height direction D3, however, the current values to be applied to the light-emitting elements 41 may be lowered from the end portion to the central portion of the array. Even in the image display device, it is possible to obtain operational effects similar to those of the above-described embodiment, and it is possible to curb luminance unevenness in the display 5 while curbing power consumption.

According to the image display device of the present embodiment, it is possible to curb display luminance unevenness.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image display device comprising:
a display unit configured to emit display light; and
an optical unit configured to reflect the display light and project the display light to a display member, wherein
the display unit includes a circuit board on which a plurality of light-emitting elements is mounted, a display that receives light emitted from the light-emitting element and emits the display light, and a control unit that controls light emission luminance of the light-emitting element,
the light-emitting elements are arrayed on the circuit board, and
the control unit is capable of individually adjusting the light emission luminance of the light-emitting element for each row of the array.

2. The image display device according to claim 1, wherein
the control unit adjusts the light emission luminance by lowering a current value to be applied to the light-emitting element from an end portion to a central portion of the array.

3. The image display device according to claim 1, wherein
the circuit board is a metal circuit board on which the plate-shaped metal member is stacked.

4. The image display device according to claim 2, wherein
the circuit board is a metal circuit board on which the plate-shaped metal member is stacked.
